(19) United States
(12) Patent Application Publication
(10) Pub. No.: US 2005/0226533 A1
(43) Pub. Date: Oct. 13, 2005

(54) Method for measuring the location of an object by phase detection

(76) Inventors: Patrick Sandoz, Nimes (FR); Philippe Gerard Lucien Humbert, Ornans (FR); Vincent Bonnans, Besancon (FR); Tijani Gharbi, Besancon (FR)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/506,021

(22) PCT Filed: Feb. 27, 2003
(86) PCT No.: PCT/FR03/00636

§ 371 Date: Mar. 24, 2005

(30) Foreign Application Priority Data
Feb. 28, 2002 (FR) 02/02547

(51) Int. Cl. G06K 9/36

(52) U.S. Cl. 382/287; 382/289; 382/291

(57) ABSTRACT

A method for measuring the location of an object in an observed space by means of a fixed observation system connected to a processing unit for generation of an image comprising a pixel matrix, the object being provided with a test marker. The test marker comprises a periodic pattern in two dimensions and a digital processing of the image of the test marker is carried out to produce an image comprising a first grating and an image comprising a second grating which are analyzed digitally to calculate the position of the test marker within the matrix of pixels.

The present invention relates to a method for measuring the location of an object by phase detection.

More particularly, the invention concerns a method for measuring the location of an object observed by a fixed observation system connected to a processing unit, in order to generate an image composed of a matrix of pixels.

In order to locate the object precisely, the latter is provided in a manner which is known per se with a test marker having two periodic gratings, the representation of which in the pixel matrix is formed by two periodic gratings intended, after conversion to the frequency domain, to constitute two bidirectional phase references which can be processed by extracting the phase information by means of a frequency analysis function such as Morlet wavelet transforms. The phase information detected in this way is then combined in order to determine the cartesian coordinates of the reference point of the test marker, as well as the orientation of the test marker with respect to the observation system. Application of this measurement method to the image of a suitable test marker, obtained by a standard sensor, allows high resolution in the location of the reference point of the test marker. Such a measurement method is described in an article in the journal “IEEE TRANSACTIONS ON INSTRUMENTATION AND MEASUREMENT” volume 49, number 4, pages 867 to 872.

This measurement method consist basically in using a test marker formed by a first grating comprising a plurality of parallel and regularly spaced first strips, and by a second grating comprising a plurality of parallel and also regularly spaced second strips. These first and second gratings are furthermore arranged so that the first strips are substantially perpendicular to the second strips, although the first and second gratings are physically separated by a certain distance from one another.

The image of this test marker in the pixel matrix obtained by the observation system, or more specifically the image of the two gratings, is then processed by the processing unit in order basically to carry out the following operations for each grating:
locating and extracting the image of the grating from the entire matrix of pixels,
calculating the pixel frequency of this grating along a first alignment of pixels which intersects all the strips of this grating,
using the pixel frequency of this grating in order to define an analysis function which is applied to this grating along the first alignment of pixels,
extracting the phase and the modulus which are associated with this grating, by correlation with the analysis function, in order to calculate the cartesian position of the middle of at least one strip of the grating in the direction of the first alignment of pixels,
successively extracting the phase and the modulus which are associated with this grating, by correlation with the analysis function along a plurality of pixel alignments which are parallel to the first alignment of pixels, in order to independently determine the cartesian position of each middle of said at least one strip in the direction of each corresponding alignment of pixels,
for each grating, calculating a median line passing substantially through all the middles of said corresponding at least one strip, the median line of the first grating being perpendicular to the median line of the second grating,
calculating the cartesian position of the point of intersection between the two median lines, and
calculating the angle defined by the median strip of the first grating and a predetermined alignment of pixels.

An example of a known device for carrying out the method as described above is schematically represented in FIG. 1.

This device comprises an observation system 1 comprising a matricial image sensor such as a CCD camera 2, and a lens 3 for forming the image of the observed scene on the matricial image sensor 2. This matricial image sensor is connected to a processing unit 4 intended to make it possible to analyze the phase of the image formed by a pixel matrix obtained using the matricial image sensor 2. This processing unit 4 is also designed to carry out logical and arithmetic operations on the recorded images coming from the matricial image sensor. In order to permit position measurements of an object 5 moving in the fixed observation field of the sensor 2, a test marker 6 is fixed on this mobile object 5. The test marker 6 comprises a first grating P1 formed by N1 parallel and regularly spaced strips, and a second grating P2 formed by N2 parallel and regularly spaced strips. These two gratings P1, P2 are physically separated from each other, and the N1 strips are substantially perpendicular to the N2 strips of the second grating P2.

The gratings P1 and P2 are, for example, etched by photolithography on a glass mask, the latter being illuminated by a lighting device making it possible to obtain a matrix of pixels, representing the images of the gratings P1 and P2, from the matricial image sensor.

After the various operations of processing the recorded image of this test marker 6 by means of the processing unit 4, these various processing operations being described in more detail in the rest of the description, a cartesian representation of the test marker 6 is obtained as can be seen in FIG. 2.

In the example in question, the processing unit 4 therefore makes it possible to calculate the equation of a line D2 of the grating P2 and the equation of a median line D1 of the grating P1, these median lines D1 and D2 being respectively defined by all the middles of the central strip of each grating P1 and P2 in the assembly in question. The position of the test marker 6, and therefore of the object 5, is given by the cartesian coordinates Δx, Δy of the point of intersection P of the two median lines D1 and D2.

The orientation of the object 5 is in turn defined by the angle θ formed, for example, by the median line D1—selected as a reference—of the grating P1 with one of the cartesian reference-coordinate axes x, y provided, for example, by the matrix of pixels constituting the image.

With this type of measurement method, and after recording and analysis of two consecutive images of the test marker 6, it is possible to detect displacements of the object 5 with a precision of the order of 1.10⁻² pixel.

But the use of a test marker that has two periodic gratings physically separated from each other, as can be seen in FIG. 2, means that the point of intersection P of the two median lines D1 and D2 lies inside the second grating P2 but at a relatively large distance from the first grating P1. In the event that there is the slightest error in the calculation of the slope of the reconstructed median line D1, therefore, it can be seen that this error will automatically be passed on to the position of the point P along the median line D2. This positioning error of the point P along the median line D2 will be commensurately larger when the grating P1 is further away from the grating P2.

It is, in particular, an object of the invention to overcome the aforementioned drawbacks.

To this end, according to the invention, the measurement method of the type in question is essentially characterized in that it comprises the following steps:
a test marker is used comprising at least one two-dimensional periodic pattern formed by a plurality of substantially point-like elements arranged in parallel rows and parallel columns, which are substantially perpendicular to the rows, the point-like elements being regularly spaced along the rows and the columns,
a first image of the pattern is recorded, and digital processing of the first image of the pattern is carried out in order to generate, from said pattern, an image containing a first grating comprising a plurality of regularly spaced parallel first strips and an image containing a second grating comprising a plurality of regularly spaced parallel second strips, the second strips being substantially perpendicular to the first strips, and for each of the first and second gratings,
the pixel frequency of this grating is calculated along a first alignment of pixels which intersects all the strips of this grating,
the pixel frequency of this grating is used to define an analysis function which is applied to this grating along the first alignment of pixels,
the phase and the modulus which are associated with this grating are extracted by correlation with the analysis function in order to calculate the cartesian position of the middle of at least one strip of the grating in the direction of the first alignment of pixels,
the phase and the modulus which are associated with this grating are successively extracted by correlation with the analysis function along a plurality of pixel alignments which are parallel to the first alignment of pixels, each alignment of pixels intersecting all the strips of this grating, in order to independently determine the cartesian position of each middle of said at least one strip in the direction of each corresponding alignment of pixels,
a median line passing substantially through all the middles of said at least one strip is calculated for each grating, the median line of the first grating being perpendicular to the median line of the second grating,
the cartesian position of the point of intersection between the two median lines is calculated, and
the angle defined by the median line of the first grating and a predetermined alignment of pixels is calculated.

In preferred embodiments of the invention, one and/or other of the following arrangements may optionally be employed as well:
a second image of said at least one periodic pattern is recorded after a displacement of the object in the space observed by the fixed observation system, and the cartesian position of the point of intersection of the two median lines of the first and second gratings as obtained from the second recorded image is calculated in order to calculate the displacement of the object;
the digital processing of the first image of said at least one periodic pattern comprises the following steps:
   a forward Fourier transform is applied to the image of the pattern in order to obtain the Fourier spectrum of the image of said periodic pattern,
   based on the Fourier spectrum, two independent filtering operations are carried out in order to obtain, on the one hand, a first filtered Fourier spectrum associated with the direction of the columns of the periodic pattern and, on the other hand, a second filtered Fourier spectrum associated with the direction of the rows of the periodic pattern, and
   an inverse Fourier transform is applied to each of the first and second filtered Fourier spectra in order to obtain the image of the first grating and the image of the second grating;
the test marker comprises a matrix of identical periodic patterns arranged in parallel rows and parallel columns, which are substantially perpendicular to the rows, the periodic patterns being regularly spaced along the rows and the columns, and each periodic pattern being associated with a positioning element for locating the periodic pattern which is associated with it inside the matrix of periodic patterns;
each positioning element comprises a row number index and a column number index for making it possible to locate the pattern which is associated with it inside the matrix of periodic patterns;
the image of each row number index and column number index in the matrix of pixels is in the form of a barcode which is read by the processing unit;
the fixed observation system comprises a first and a second matricial image sensor which are contained substantially in a plane perpendicular to a plane defined by the two dimensions of the periodic pattern of the test marker, the first and second image sensors having sighting axes each of which delimits a predetermined angle with the axis perpendicular to the plane, and
   an image of said at least one periodic pattern is recorded by each sensor,
   the first cartesian position of the point of intersection as obtained from the first sensor is calculated,
   the second cartesian position of the point of intersection as obtained from the second sensor is calculated, and
   based on the first and second cartesian positions of the point of intersection and the predetermined angles, the position of the point of intersection is calculated along a direction parallel to the plane defined by the two dimensions of said at least one periodic pattern and a direction perpendicular to the plane defined by the two dimensions of said at least one periodic pattern;
the fixed observation system comprises a first matricial image sensor that has a sighting axis perpendicular to the plane defined by the two dimensions of the periodic pattern of the test marker and a second matricial image sensor that has a sighting axis parallel to the plane defined by the two dimensions of the periodic pattern of the test marker, a light-beam splitting object being furthermore interposed between the periodic pattern and the first and second sensors, and
   an image of said at least one periodic pattern is recorded by each sensor,
   the cartesian position of the point of intersection in a plane parallel to the plane defined by the two dimensions of the periodic pattern is calculated from the image obtained by the first sensor, and
   the cartesian position of the point of intersection in a plane perpendicular to the plane defined by the two dimensions of the periodic pattern is calculated from the image obtained by the second sensor;
the frequency of the periodic pattern, as calculated by the processing unit, is compared with the real frequency of the periodic pattern in order to determine the position of the point of intersection in a direction perpendicular to the plane defined by the two dimensions of said at least one periodic pattern, as a function of the magnification index of the fixed observation system.

Other characteristics and advantages of the invention will become apparent from the following description of one of its embodiments, which is given by way of a nonlimiting example, with reference to the appended drawings.

### IN THE DRAWINGS:

FIG. 1 represents the device for carrying out the aforementioned method according to the prior art,

FIG. 2 represents an example of a strip grating according to the prior art for the position calculation,

FIG. 3 represents a measurement device for carrying out the method according to the invention,

FIG. 4 represents a test marker according to the invention for facilitating a position calculation,

FIG. 5 represents an image of the test marker according to the invention, obtained using the observation system of the device,

FIG. 6 represents an enlargement of a portion of the image of the test marker in FIG. 5,

FIG. 7 represents the Fourier spectrum of the image of the test marker according to the invention,

FIGS. 8a and 8b represent a reconstruction of the Fourier spectrum, respectively in the direction of the columns of the test marker and in the direction of the rows of the test marker,

FIGS. 9a and 9b are views of the pixel-based spatial representations of two gratings, obtained by the frequency processing of the image of the test marker,

FIGS. 10a and 10b represent regions of interest in the gratings of FIGS. 9a and 9b, for facilitating the position calculation,

FIG. 11 represents the intensity of the signal emitted by the grating in FIG. 10b along a column,

FIG. 12 is a view of the Fourier spectrum of the intensity of the signal as represented in FIG. 11,

FIG. 13 represents the modulus of the wavelet transform along the column C_{c} as represented in FIG. 10b,

FIG. 14 represents the phase of the wavelet transform along the column C_{c} as represented in FIG. 10b,

FIG. 15 represents the product of the derivative of the modulus as represented in FIG. 13 multiplied by the phase as represented in FIG. 14 (the peaks defining the ends of the strip grating along the column C_{c} represented in FIG. 10b);

FIG. 16 represents the superposition of the developed phase and the intensity along the column C_{c} in FIG. 10b,

FIGS. 17, 18 and 19 represent the images of the strip gratings as reconstructed by the digital processing, as well as the secant line as calculated from each of the strip gratings and their point of intersection that represents the position of the mobile object with respect to the fixed reference coordinates formed by the frame of the pixels of the recorded image,

FIG. 20 represents an alternative embodiment of the test marker according to the invention,

FIGS. 21 and 22 represent positioning elements intended to be formed on the test marker represented in FIG. 20,

FIG. 23 represents an alternative embodiment of the device for carrying out the method according to the invention,

FIG. 24 represents another alternative embodiment of the device for carrying out the method according to the invention, and

FIG. 25 represents yet another alternative embodiment of the device for carrying out the method.

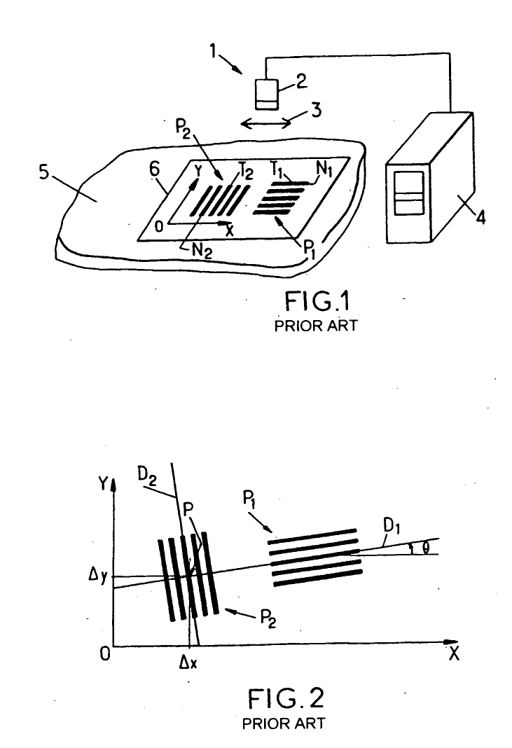

In the various figures, references that are the same denote identical or similar elements.

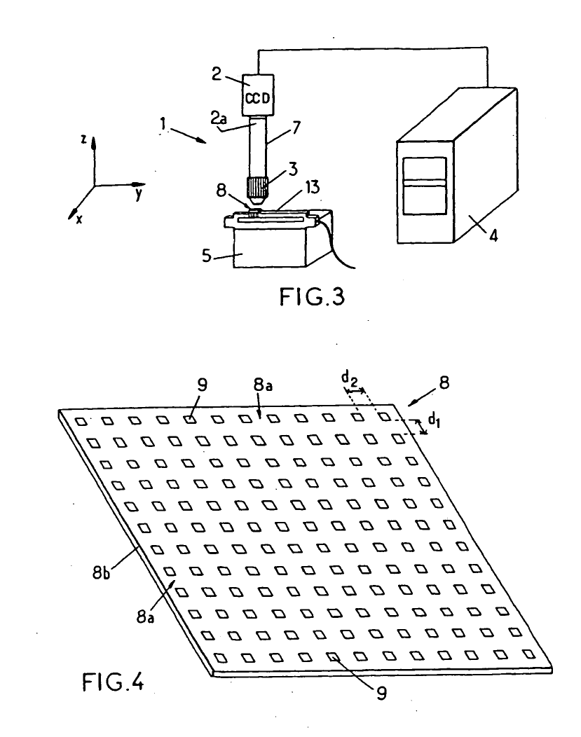

FIG. 3 represents an example of a measurement device needed for carrying out the method according to the invention. This device comprises a matricial image sensor such as a CCD camera 2, a microscope objective 3 and a matching tube 7 that connects the sensor 2 to the microscope objective 3 in order to form the observation system 1 of said device. The device may, of course, simply comprise an imaging lens and a matricial image sensor. This observation system 1 is intended to remain immobile. An object 5 is placed in the field of view of the sensor 2 and this object 5 is provided with a test marker 8 fixed on the support or more specifically, in the example in question, on a back-lighting table 13 itself fixed on the object 5. This object 5 is intended to move in a two-dimensional space defined by the plane [xoy]. Furthermore, the sensor 2 is also arranged so that its viewing axis 2a is substantially perpendicular to the plane [xoy]. In this embodiment, the test marker 8 as represented in FIG. 4 comprises a two-dimensional periodic pattern 8a formed by a plurality of point-like elements 9 arranged in parallel rows (of which there are 12 in the example in question) and parallel columns (of which there are also 12 in the example in question) which are perpendicular to the rows. The test marker 8 may, for example, be formed by a glass mask 8b covered with a layer that is opaque over its entire surface and in which the transparent point-like elements 9 are obtained by photolithography, so that the surface of the test marker 8 is opaque except at the point-like elements 9. The number of rows and columns of the test marker 8 may of course vary significantly according to the type of test marker used, without thereby departing from the scope of the invention.

In order to obtain an image of the test marker by means of the sensor 2, the test marker 8 is arranged above a diffuse lighting table 13 so that the point-like elements 9 produce luminous points that are distributed over the dark background of the test marker and can be detected by the matricial image sensor. One variant might consist in providing the point-like elements 9 with a different reflectivity than the rest of the test marker, so that these point-like elements have a different luminosity than the rest of the test marker, the assembly being illuminated from below.

The test marker 8 is furthermore arranged so that its periodic pattern 8a is substantially arranged in the reference plane [xoy].

The distance d1 between two rows of the periodic pattern 8a and the distance d2 between two columns are constant, while the distance d2 may be equal to or different than the distance d1.

For example, the point-like elements 9 may be of substantially square shape with sides that have a length of the order of 5 μm.

Of course, the test marker 8 may also be formed by any support on which the point-like elements 9 are arranged, which may also be in the form of reflective elements that reflect the light from an excitation source illuminating the test marker 8 so as to obtain an image of a periodic grating at the sensor.

Likewise, according to an alternative embodiment, the test marker 8 may also be formed by a support on which a plurality of periodic through-holes 9 are formed, making it possible to obtain an image of a periodic grating after illumination by a back-lighting table.

FIG. 5 represents an image of the test marker 8 as represented in FIG. 4, this image being taken by a CCD sensor with a matrix of pixels measuring 578 pixel rows by 760 pixel columns.

The first step of the method consists in carrying out preliminary digital processing of the image of this test marker 8 in order to computer-generate two separate images, respectively representing a first grating formed by a first series of parallel strips and a second grating formed by a second series of parallel strips, which are perpendicular to the first series of strips.

To this end, the processing unit 4 (FIG. 3) of the device is used to record the image of the test marker 8, which is represented in FIG. 5 and is obtained by the CCD sensor.

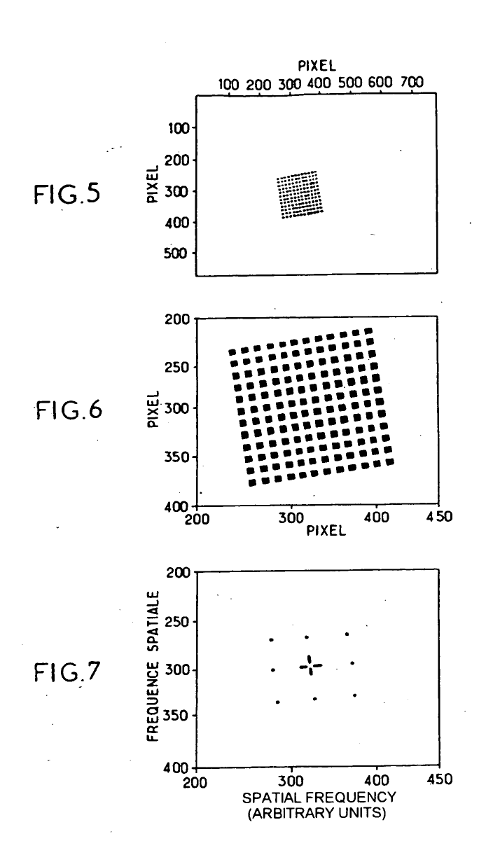

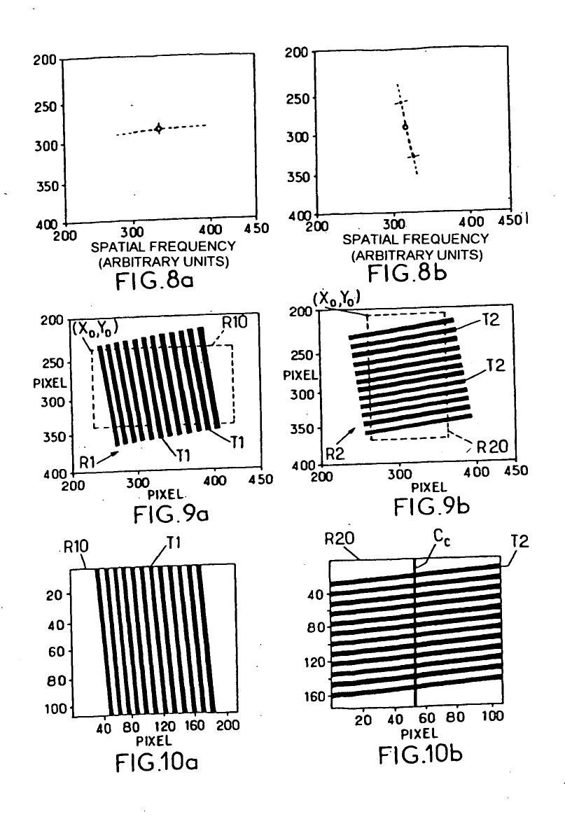

On the basis of the image of this test marker 8, an enlargement of which is represented in FIG. 6, frequency processing of this image is first carried out in order to change from the spatial domain to a frequency domain. This frequency processing consists, for example, of a forward Fourier transform in order to obtain the Fourier spectrum of the recorded image of the two-dimensional periodic pattern 8a of the test marker 8, as can be seen in FIG. 7. On the basis of this Fourier spectrum, two suitable and independent filtering operations are carried out in order to obtain, on the one hand, a filtered Fourier spectrum associated with the direction of the rows of the periodic pattern of the test marker (FIG. 8a) and, on the other hand, a filtered Fourier spectrum associated with the direction of the columns of the periodic pattern of the test marker (FIG. 8b).

An inverse Fourier transform is then applied to each of the filtered Fourier spectra as represented in FIGS. 8a and 8b in order to obtain the images of two gratings R1 and R2 (FIGS. 9a and 9b) in a pixel-based spatial representation, these two gratings R1 and R2 being representative of the periodic pattern 8a of the test marker 8.

In the example considered in FIGS. 9a and 9b, the grating R1 is therefore formed by 12 mutually parallel and substantially vertical strips T1, while the grating R2 is formed by 12 likewise mutually parallel but substantially horizontal strips T2.

Advantageously, the phase information associated with the rows and the columns of the periodic pattern 8a is preserved by this frequency processing of the recorded image of the test marker 8 as represented in FIG. 6, and the gratings R1 and R2 generated in this way contain all the positional information already available from the test marker 8, or more specifically from the recorded digital image of the periodic pattern 8a of the test marker 8.

Calculation of the location of the test marker 8 in the image thus equates to respectively calculating the location of the grating R1 in the first generated image and the location of the grating R2 in the second generated image.

In order to make it possible to calculate the position of each grating, a calculation which equates to determining the position and the orientation of each grating in its image, a region of interest R10, R20 is first defined for each grating R1, R2. This region of interest R10, R20 in each grating R1, R2 is determined by systematically excluding the extreme edges of the strips T1, T2.

Each region of interest R10, R20 comprises sides which are pairwise parallel to the axes defined by the pixel frame of the sensor, that is to say the row axis and the column axis of the matrix of pixels.

When the orientation of the gratings R1 and R2 makes the regions R10, R20 very narrow, a prior rotation of the recorded image of the test marker is thus applied so that the regions of interest R10, R20 are large enough to ensure accuracy of the measurements.

The subsequent processing operations are only carried out in these regions of interest R10, R20, which represent the only parts of the images of the gratings R1 and R2 that can be used for the position and orientation calculation.

FIGS. 10a and 10b respectively give the pixel-based images of the two regions of interest R10, R20.

For each region of interest R10, R20, the pixel coordinates of the upper left-hand edge of the region of interest as well as its height and its width in pixels are also determined with respect to the original image as represented in FIG. 5. The following are thus obtained in the examples in question:
For R1 X₀=235; Y₀=240; Height=107 pixels and width=205 pixels
For R2 X₀=205; Y₀=240; Height=170 pixels and width=105 pixels

In the rest of the description, we will determine the position and the orientation of each grating in the original image of the test marker 8 as given in FIG. 5.

Given that the various processing operations to be described below are identical for the gratings R1 and R2, in what follows we will only study the case of the grating R2 formed by 12 substantially horizontal strips T2 with reference to the pixel rows of the image.

The pixel-based spatial frequency of the grating R2 is determined first of all. The spatial frequency of the grating R2 is determined, for example, by Fourier transformation. The frequency of the imaged strip grating corresponds to a maximum in the Fourier spectrum.

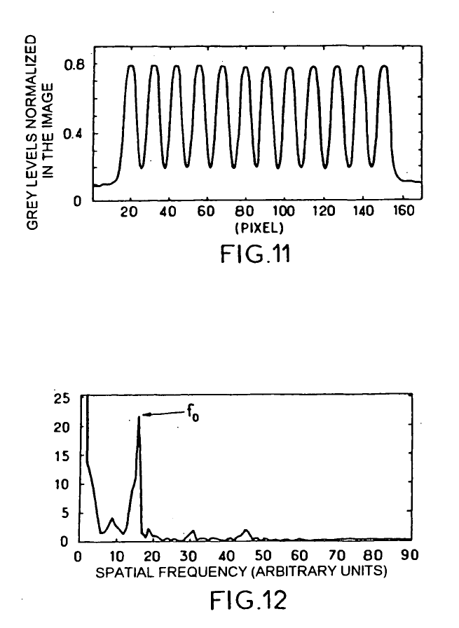

To this end, a column of pixels C_{c} is considered (FIG. 10.b) along which the intensity of the signal received by the matricial image sensor is determined. On the-basis of the intensity of the signal along the column C_{c} as represented in FIG. 11, the processing unit determines the Fourier spectrum of the intensity of the signal along this column C_{c}, as indicated in FIG. 12. After exclusion of the low frequencies of the image, which correspond to the continuous background, it is then possible to extract the spatial frequency fₒ of the imaged grating R2.

In order to avoid making an error when determining the frequency of the grating, it is also possible to use all the a priori knowledge about the imaged grating R2. For instance, knowing the number of substantially horizontal strips of the imaged grating R2, this number of strips being identical to the number of rows of elementary elements 9 in the pattern of the test marker 8, and knowing the approximate size of the region of interest R20 of the grating R2, that is to say its height and its width, it is possible to ascertain approximately the period of the grating in pixels and therefore its frequency fₒ.

An analysis function is then constructed for this same frequency fₒ of the grating R2, this frequency being determined on the basis of the pixel column C_{c} with reference to the pixel matrix of the matricial image sensor.

For example, the analysis function may be a Morlet wavelet which makes it possible, by correlation with the grating R2, to extract the phase and the modulus that are associated with this grating.

The Morlet wavelet at the frequency fₒ for processing the image is of the form:
Ψ(y)=exp−(y/Lw)².expj(2πfₒy)
where Lw defines the width of the wavelet. This parameter Lw can prove to be important because the choice of its value determines the compromise between the spatial and frequency resolutions. For instance, a short wavelet makes it possible to obtain a good spatial resolution, but the information about the phase is very poor in this case. In the converse case of a long wavelet, the spatial information is insufficient but a good resolution is obtained for the phase.

In the case of a discrete signal like that delivered by a matrix image sensor such as a CCD camera, it is of course necessary to introduce a discrete form of the wavelet in the form:
Ψ(j)=exp−(i/Lw)².expj(2πfₒi)
where i is an integer value lying between −M and M. The value of M must in this case be matched to the length of the wavelet, that is to say the parameter Lw, in order to insure a complete representation of the wavelet.

For each position k along a column 1 parallel to the column C_{c} (FIG. 10.b), the coefficient Wₖ, 1 of the wavelet transform is thus given by the following expression:

$${W}_{k} , l = {\sum }_{i = - M}^{+ M} I ( k + i , l ) {ψ}_{i}$$

where I(k, l) is the intensity of the pixel k in the column l.

Since the purpose of the image processing is to reconstruct the total phase excursion of the imaged grating R2, which is equal to 2Nπ were N is equal to the total number N2 of strips of the grating R2, it is therefore necessary to extract the phase of the wavelet transform, which is itself equal to 2Nπ apart from the noise.

The phase and the modulus are respectively given by the argument and the modulus of the complex number W_{k,l}. But since the frequency of the wavelet is fixed at f^{o}, which is the pixel frequency of the grating R2 along the column C_{c}, the wavelet transform of the grating R2 equates to a convolution between the wavelet and the imaged grating R2 in one direction.

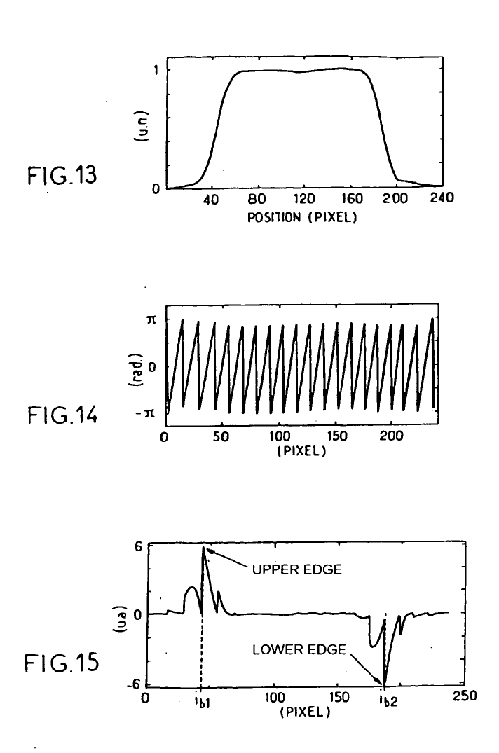

After calculation, the processing unit thus makes it possible to extract the modulus and the phase of the wavelet transform along the column C_{c}. The representations of the modulus and the phase of this wavelet transform along the column C_{c} are respectively given by FIGS. 13 and 14.

It is then necessary to determine the edges of the grating R2 along the column C_{c}, in order to extract the useful part of the phase of the wavelet transform. Specifically, the purpose of the digital processing is to reconstruct the phase excursion 2Nπ or N=12 in the example in question.

The following operation may in particular be used to this end, where the derivative of the modulus is multiplied by the phase of the wavelet transform. More specifically, the following operation may be carried out:
B(i,j)=M′(i,j)×|P(i,j)−π|
where M′(i,j) is the derivative of the modulus of the wavelet transform along the column j, i is the index of the row, and P(i,j) is the phase of the wavelet transform.

The result of this operation along the column C_{c} is represented in FIG. 15, where the indices ib₁ and ib₂ correspond respectively to the upper and lower edges of the grating R2 along the column C_{c}.

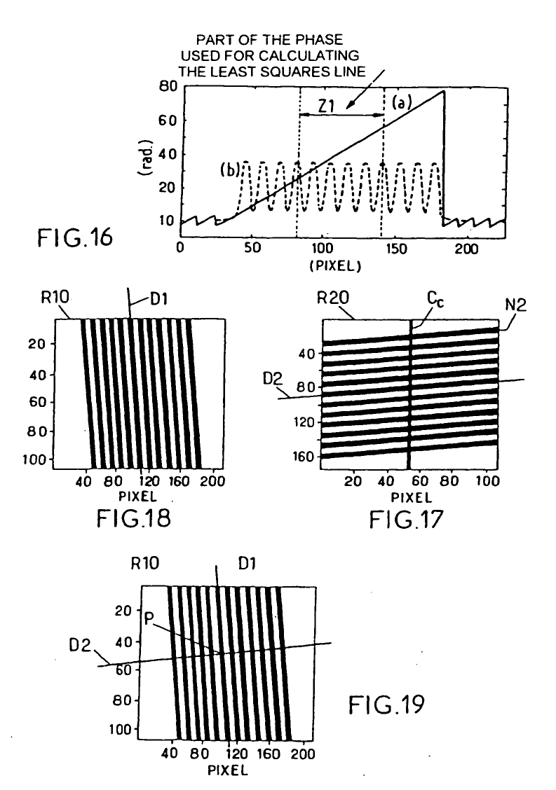

The indices ib₁ and ib₂ now being perfectly determined, it is then possible to reconstruct the phase excursion of 2Nπ. The processing unit is used to carry out superposition of the phase developed over the entire grating, that is to say between ib₁, and ib₂, and the intensity variation along the column C_{c}, as represented in FIG. 16.

After having reconstructed the phase excursion, the least squares line that passes through the points of the developed phase is then calculated. The calculation is limited to a region Z1 (FIG. 16) where the phase calculation is optimal for avoiding the errors due to edge effects.

This least squares line makes it possible to convert from the discrete domain of the image to a continuous space, this least squares line having an equation:
J=I.a+b
where I and J are continuous variables.

It is deduced from this equation that the centre of the N2 strips of the grating as well as the centre of the bands lying between two strips of the grating R2 are solutions of the two equation of the following type:
(2k−1).π=Ia+b; for the strips with 1<k<n
and 2kπ=Ia+b; for the bands with −1<k<n
where b corresponds to the cartesian ordinate at the origin and a corresponds to the slope of the least squares line.

The equations may of course be different according to whether the observation is bright on a dark background or dark on a bright background, which will depend on the test marker and the lighting which is used.

Based on these equations, the subpixel position of the middle of the strips and the bands of the grating R2 along the column C_{c} are then determined.

At this stage of the processing of the imaged grating R2, for example, the middle of the sixth strip of the grating R2 along the column C_{c} may be adopted as a reference point. All of the processing described above is then repeated for a plurality of pixel columns which are parallel to the column C_{c} and which pass through all the N2 strips of the imaged grating R2. After scanning the imaged grating, a plurality of mutually independent points are then obtained which represent the cartesian coordinates of the middle of the sixth line of the grating R2 along each pixel column. When all the middles of the sixth strip of the grating R2 have been calculated, it is then sufficient to determine the least squares line D2 defined by the alignment of these middles, as represented in FIG. 17. When the least squares line D2 or median line D2 has been determined, the processing of the imaged grating R1 formed by N1 strips is then carried out (FIG. 10a).

In order to obtain the least squares line D1 or median line D1 passing through all the middles of the sixth strip of the imaged grating R1, it is sufficient to resume all the processing operations described above while scanning the grating R1, or more specifically the region of interest R10, along a plurality of pixel rows. The line D1 represented in FIG. 18 is then obtained. At this stage of the processing, it is then sufficient to virtually superpose the two images of the gratings R1 and R2, or at least to project the median line D2 onto the imaged grating R1, for example, as can be seen in FIG. 19, in order to obtain the intersection of the two lines D1 and D2, which gives the measurement point P associated with the test marker 8.

For example, the line D1 has an equation
y=6.5221×−2148.6 (D1)
and the line D2 has an equation
y=−0.1524×+230.4403

Using this measurement method, the position of the point P is determined with a precision of the order of one 100^{th} of a pixel. Furthermore, the reconstruction of two imaged gratings R1 and R2 from the periodic pattern 8a of the test marker 8 makes it possible to superpose the imaged gratings R1 and R2 while preserving the positional information of the test marker 8, which makes it possible to obtain a point of intersection P lying inside the two imaged gratings R1 and R2. This location of the point P inside the two imaged gratings makes it possible to considerably minimize the effect of the least error in the calculation of the slope of the median lines D1 and D2, which are reconstructed by the processing described above.

In all of the method described above, the test marker 8 comprises a single periodic pattern 8a. The presence of a single periodic pattern thus makes it possible to measure the subpixel displacement by successively recording two images of the test marker 8. Thus when the object 5 and therefore the test marker 8 move by a fewer nanometers, as seen above, the position of the illuminated pixels in the image of the test marker 8 is not modified but their intensity values change slightly. This is because the light intensity distribution incident on the pixels of the matricial image sensor changes, giving rise to a different recorded image of the test marker, which leads to a different phase during the digital processing and therefore to measurement of the new position of the mobile target. The value of the displacement is provided by the difference between the positions measured before and after the displacement. In other words, therefore, these variations together lead to a significant variation of the phase between the two images. This modification of the phase distribution is detected and measured by the method described above, which makes it possible to calculate the new cartesian coordinates of the point of intersection P of the median lines D1 and D2 for the second recorded image of the test marker 8. The value of the displacement of the point of intersection P, and therefore of the target object, is thus determined by using the slope of one of the median lines D1 or D2 and the respective cartesian coordinates of the point of intersection P in the first image and in the second recorded image.

When a test marker comprising a single periodic pattern is used, however, the measurement of displacement based on two recorded images is limited by the fact that the entire periodic pattern 8a of the test marker 8 must necessarily be contained in the pixel matrix of the matricial image sensor. But in the event that the displacement of the test marker 8 is too large, at least some of the periodic pattern is liable to leave the field of view of the fixed sensor, which then makes it impossible to determine the position of the point P and the angular orientation of the test marker 8.

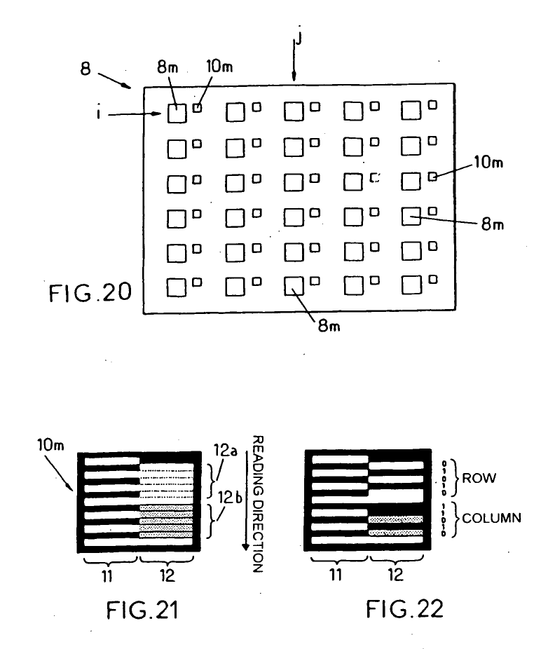

According to an alternative embodiment of the invention, which is represented in FIG. 20, the test marker 8 is provided with a plurality of periodic patterns 8n that are identical to the periodic pattern 8a. The periodic patterns 8n are arranged regularly, for example periodically in parallel and regularly spaced rows as well as in parallel columns, which are perpendicular to the rows.

Each periodic pattern is, for example, etched by photolithography. As can be seen in FIG. 20, each periodic pattern 8n has a positioning element 10n associated with it, which is designed to store positional information making it possible to locate the periodic pattern associated with it actually inside the matrix formed by all the periodic patterns 8n. Each positioning element 10n includes, for example, a row number index and a column number index making it possible to precisely ascertain the position of the periodic pattern 8n which is associated with it inside the matrix of periodic patterns.

Furthermore, the spacing between two adjacent periodic patterns 8n is physically known since it was chosen when designing the test marker 8. The displacements can therefore be measured with two degrees of precision, that is to say the spacing between two periodic patterns and a subpixel precision actually inside the image of the periodic pattern 8n which is being processed by the processing unit 4. In other words the displacements are calculated on the basis of two complementary values, that is to say the spacing between the patterns which are observed in the recordings before and after displacement, and the position of the pattern which is observed in the pixel matrix of the images that are recorded before and after displacement. During a first location measurement of the test marker, for example, the processing unit may process the recorded image of a periodic pattern seen in its entirety by the observation system. This periodic pattern 8n is localized in the matrix of patterns by its row index i1 and its row index j1. The processing unit can then determine the location point P of this pattern by means of the various processing operations described above, this being done for example for the sixth strip of its imaged gratings R1 and R2.

When there is a significant relative displacement of the test marker 8, which corresponds to a displacement in excess of the size of the periodic pattern processed previously, the field of view of the sensor then detects another periodic pattern. Owing to its positioning element, this other pattern is localized in the matrix of patterns by its row index i2 and its row index j2. The processing unit can then determine the location point P of this new periodic pattern by taking the sixth strip of its imaged gratings R1 and R2 as a reference. The displacement of the test marker 8 is therefore deduced from this processing, which in this example equates to calculating the known spacing between the rows i1 and i2 and the columns j1 and j2 and the subpixel displacement by means of the two location points P of the two periodic patterns.

FIG. 21 represents an embodiment of a positioning element 10n according to the invention. In this embodiment, the positioning element basically comprises a reference part 11 and an information-writing part 12 intended to make it possible to locate the periodic pattern which is associated with it.

The reference part 11 of each positioning element is in the form of a succession of white and black bands, for example, so that the processing unit 4 can be used to read the part 12. This information writing part 12 includes, for example, a portion 12a for writing a row number i and a portion 12b for writing a column number j, the two portions 12a and 12b each being formed by five bands arranged in alignment with the white and black bands of the reference part 11.

In this example, each positioning element 10n makes it possible to encode 10 bits of information (5 bits for the rows and 5 bits for the columns), thus making it possible to work with matrices of 32×32 periodic patterns 8n.

It can thus be understood that the use of a matrix of periodic patterns makes it possible to increase the distance measurements up to a distance which is fixed only by the size of the matrix itself, and no longer by the size of the periodic pattern considered on its own.

The bands forming the two portions 12a and 12b are also obtained when etching the test marker, and black or white bands may be formed according to the position assigned to each positioning element.

As an example, FIG. 22 represents a positioning element 10n which is obtained by photolithography and which is intended to precisely locate a periodic pattern in the matrix of patterns.

The information writing part of this element is read by the processing unit from the top down, for example, and makes it possible to obtain the following information by binary reading:
for the row=01010, which corresponds to row i=10 and
for the column=11010, which corresponds to column j=26.

Use of the matrix of periodic patterns 8n which are associated with positioning elements furthermore offers the opportunity to detect a periodic pattern lying close to the centre of the image of the sensor, which thus makes it possible to reduce the distortions due to the optics of the objective.

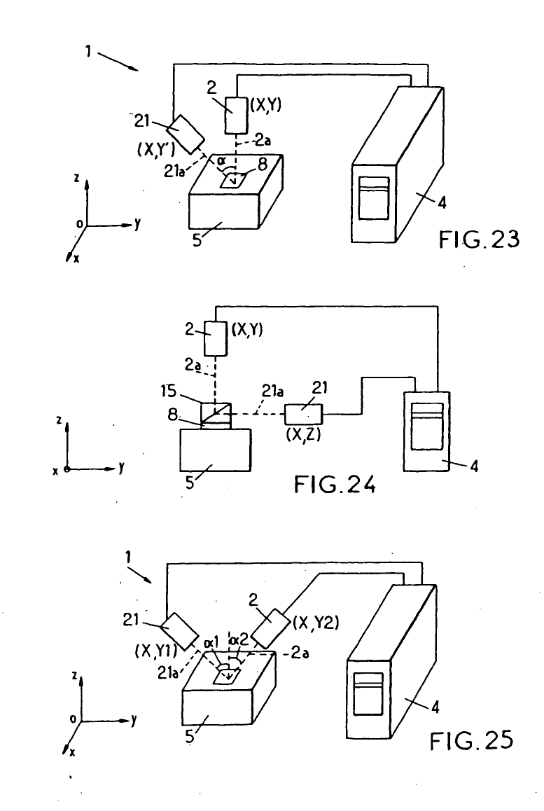

According to an alternative embodiment of the invention, which is represented in FIG. 23, the object 5 on which the test marker 8 is placed is intended to move both in the plane (XOY) and in the Z direction, the displacements in the Z direction also needing to be measured by the method described above.

To this end, the fixed observation system 1 comprises a first matricial image sensor 2 as well as a second matricial image sensor 21, both of which are substantially contained in the plane (YOZ) which is perpendicular to the plane (XOY), that is to say perpendicular to the plane defined by the two dimensions of the periodic pattern of the test marker 8.

Furthermore, the first sensor 2 has a sighting axis 2a which extends along the axis (OZ) and the second sensor 21 has a sighting axis 21a which makes an angle α with the axis (OZ), this angle α being determined when assembling the two sensors 2 and 21.

The two sensors are also arranged so that the point of intersection of the two sighting axes 2a and 21a lies in the vicinity of the test marker 8.

Using this device, it is now possible to record an image of the same periodic pattern of the test marker 8 for each of the sensors 2 and 21. It is then sufficient to calculate the first cartesian position (x, y) of the point of intersection P, as obtained using the first sensor 2, and also to calculate the second cartesian position (x, y′) of the same point of intersection P as obtained using the second sensor 21. After these calculations, and if the two sensors 2 and 21 are actually contained in the same plane (YOZ), then the cartesian values (x, y) and (x, y′) of the point of intersection P should have the same value x.

The value y′ given from the image which is obtained by the second sensor 21, however, is different than the value y obtained from the image of the first sensor 2. This is because this value y′ depends on the value of the angle α as well as on the position of the point of intersection P along the Z axis.

More specifically, and after simple trigonometric operations, the value y′ can be expressed in the following way:
y′=y cos α−Z sin α

From which the value of Z is deduced, which is written in the following way:
Z=(y cos α−y′)/sin α

Simply by having the cartesian positions of the point of intersection P from the two sensors 2 and 21, and from the angle α, it is thus possible to calculate the position of the point of intersection along the Z axis.

According to this alternative embodiment, after having recorded images following a displacement of the object 5, it is thus possible to calculate the displacement of this object 5 along the axes X, Y and Z with a subpixel accuracy.

According to an alternative embodiment of the device, which is represented in FIG. 25, the sensor 2 may also have a sighting axis 2a which makes an angle α2 with the axis (OZ), the sensor 2 remaining substantially contained in the plane (YOZ) and the sensor 21 also remaining in a position in which its sighting axis 21a makes an angle α1 with the axis (OZ).

It is then sufficient to calculate the cartesian position (x, y1) of the point of intersection P, as obtained using the sensor 21, and also to calculate the second cartesian position (x, y2) of the same point of intersection P as obtained using the sensor 2. After these calculations, and if the two sensors 2 and 21 are actually contained in the same plane (YOZ), then the cartesian values (x, y1) and (x, y2) of the point of-intersection P should have the same value x.

The value y1 given from the image which is obtained by the camera 21, however, is different than the value y2 obtained from the image of the camera 2, these two values y1 and y2 themselves being different than the real value y of the point of intersection P.

In this alternative embodiment as represented in FIG. 25, two similar equations are thus obtained for the sensors 2 and 21, that is to say:
y1=y.cos α1−z.sin α1 and
y2=y.cos α2−z.sin α2

z is then given by the following equation:
z=(y2.cos α1−y1.cos α2)/(sin α1.cos α2−sin α2. cos α1)

and y is given by one or other of the following equations:
y=(y1+z.sin α)/cos α1
y=(y2+z.sin α)/cos α2

FIG. 24 represents another alternative embodiment of the device for carrying out the method of the invention.

In this alternative embodiment, the sighting axis 2a of the sensor 2 is arranged perpendicular with the plane (XOY) containing the periodic pattern of the test marker 8. The sensor 21 in turn has a sighting axis 21a which is perpendicular to the sighting axis 2a of the sensor 2, and which is consequently parallel to the plane (XOY) containing the periodic pattern of the test marker 8. A beam splitter object which is attached to the test marker 8, and which may be in the form of a cube 15 or a splitter plate, is furthermore interposed between the periodic pattern 8a or the periodic patterns 8n of the test marker 8 and the sensors 2 and 21. In this alternative embodiment, it is possible to illuminate the test marker 8 by retro lighting in order to allow some of the light beam passing through the periodic pattern of this test marker 8 to go in the direction of the sensor 2, while another part of the light beam is directed toward the sensor 21. In this case, it will be understood that after processing by the processing unit 4, the image of the first sensor 2 makes it possible to determine the cartesian position (x, y) of the point of intersection P, while the image obtained from the second sensor 21 makes it possible to calculate the cartesian position (x, z) of the point of intersection P.

According to this alternative embodiment, these coordinates (x, y, z) are thus obtained for each position of the test marker 8.

According to another alternative embodiment of the invention, which uses a device corresponding to the device represented in FIG. 3, it is also possible to calculate the z displacement of the test marker 8, that is to say a displacement in a direction perpendicular to the periodic pattern of the test marker 8, while having just one matricial image sensor.

This is because, as already seen above, the calculation of the frequency fₒ of the periodic pattern is carried out by the processing unit when a first image is recorded.

In the event that the test marker 8 is displaced along the Z axis, that is to say in the event that the periodic pattern 8a approaches the sensor 2, it will be understood that the processing of a second image will make it possible to obtain a new frequency fₒ′ of the periodic pattern, as seen and recorded by the sensor 2.

Furthermore, also knowing the magnification properties of the objective 3, it is possible to ascertain the position Z from a calibration curve established beforehand. When there is a displacement of the test marker 8 along the Z direction, it is thus sufficient to take the ratio of the frequency fₒ to the frequency fₒ′, this ratio being a function of Z only, in order to obtain the value of the position of the test marker 8 along the z axis from the calibration curve.

1. A method for measuring the location of an object (5) observed by a fixed observation system (1) connected to a processing unit (4), in order to generate an image composed of a matrix of pixels, and said object (5) being provided with a test marker (8) characterized in that the method comprises comprising the following steps:
a test marker (8) is used comprising at least one two-dimensional periodic pattern (8a) formed by a plurality of rows and parallel columns, which are substantially perpendicular to the rows, the point-like elements (9) being regularly spaced along the rows and the columns,
a first image of the pattern (8a) is recorded, and digital processing of the first image of the pattern (8a) is carried out in order to generate, from said pattern, an image containing a first grating (R1) comprising a plurality of regularly spaced parallel first strips (T1) and an image containing a second grating (R2) comprising a plurality of regularly spaced parallel second strips (T2), the second strips (T2) being substantially perpendicular to the first strips (T1), and for each of the first and second gratings,
the pixel frequency (fₒ) of this grating (R1, R2) is calculated along a first alignment (C_{c}) of pixels which intersects all the strips (T1, T2) of this grating (R1, R2),
the pixel frequency (fₒ) of this grating (R1, R2) is used to define an analysis function which is applied to this grating (R1, R2) along the first alignment (C_{c}) of pixels
the phase and the modulus which are associated with this grating are extracted by correlation with the analysis function in order to calculate the cartesian position of the middle of at least one strip (T1, T2) of the grating (R1, R2) in the direction of the first alignment (C_{c}) of pixels,
the phase and the modulus which are associated with this grating (R1, R2) are successively extracted by correlation with the analysis function along a plurality of pixel alignments which are parallel to the first alignment (C_{c}) of pixels, each alignment of pixels intersecting all the strips (T1, T2) of this grating (R1, R2) in order to independently determine the cartesian position of each middle of said at least one strip (T1, T2) in the direction of each corresponding alignment of pixels,
a median line (D1, D2) passing substantially through all the middles of said at least one strip (T1, T2) is calculated for each grating (R1, R2), the median line (D1) of the first grating (R1) being perpendicular to the median line (D2) of the second grating (R2),
the cartesian position of the point of intersection (P) between the two median lines (D1, D2) is calculated, and
the angle (θ) defined by the median line (D1) of the first grating (R1) and a predetermined alignment of pixels is calculated.

2. The method as claimed in claim 1, in which a second image of said at least one periodic pattern (8a) is recorded after a displacement of the object (5) in the space observed by the fixed observation system (1), and the cartesian position of the point of intersection (P) of the two median lines (D1, D2) of the first and second gratings (R1, R2) as obtained from the second recorded image is calculated in order to calculate the displacement of the object (5).

3. The method as claimed in one or other of claims 1 and 2, in which the digital processing of the first image of said at least one periodic pattern (8a) comprises the following steps:
a forward Fourier transform is applied to the image of the pattern (8a) in order to obtain the Fourier spectrum of the image of said periodic pattern (8a),
based on the Fourier spectrum, two independent filtering operations are carried out in order to obtain, on the one hand, a first filtered Fourier spectrum associated with the direction of the columns of the periodic pattern (8a) and, on the other hand, a second filtered Fourier spectrum associated with the direction of the rows of the periodic pattern, and
an inverse Fourier transform is applied to each of the first and second filtered Fourier spectra in order to obtain the image of the first grating (R1) and the image of the second grating (R2)

4. The method as claimed in any one of the preceding claims 1, in which the test marker (8) comprises a matrix of identical periodic patterns (8n) arranged in parallel rows and parallel columns, which are substantially perpendicular to the rows, the periodic patterns (8n) being regularly spaced along the rows and the columns, and each periodic pattern (8n) being associated with a positioning element (10n) for locating the periodic pattern (8n) which is associated with it inside the matrix of periodic patterns (8n).

5. The method as claimed in claim 4, in which each positioning element (10n) comprises a row number index (i) and a column number index (j) for making it possible to locate the pattern (8n) which is associated with it inside the matrix of periodic patterns (8n).

6. The method as claimed in claim 5, in which the image of each row number index (i) and column number index (j) in the matrix of pixels is in the form of a barcode (12a, 12b) which is read by the processing unit.

7. The method as claimed in any one of the preceding claims 1, in which the fixed observation system (1) comprises a first and a second matricial image sensor (2, 21) which are contained substantially in a first plane (yoz) perpendicular to a second plane (xoy) defined by the two dimensions of the periodic pattern (8a) of the test marker (8), the first and second image sensors (2, 21) having sighting axes (2a, 21a) each of which delimits a predetermined angle (α1, α2) with the axis (oz) perpendicular to the second plane (xoy), and
an image of said at least one periodic pattern (8a) is recorded by each sensor (2, 21),
the first cartesian position of the point of intersection (P) as obtained from the first sensor (2) is calculated,
the second cartesian position of the point of intersection (P) as obtained from the second sensor (21) is calculated, and
based on the first and second cartesian positions of the point of intersection (P) and the predetermined angles (α1 , α2), the position of the point of intersection (P) is calculated along a direction parallel to the second plane (xoy) defined by the two dimensions of said at least one periodic pattern (8a) and a direction (Z) perpendicular to the second plane (xoy) defined by the two dimensions of said at least one periodic pattern (8a).

8. The method as claimed in any one of claims 1 to 6, in which the fixed observation system comprises a first matricial image sensor (2) that has a sighting axis (2a) perpendicular to the a second plane (xoy) defined by the two dimensions of the periodic pattern (8a) of the test marker and a second matricial image sensor (21) that has a sighting axis (21a) parallel to the second plane (xoy) defined by the two dimensions of the periodic pattern (8a) of the test marker (8) light-beam splitting object (15) being furthermore interposed between the periodic pattern (8a) and the first and second sensors (2, 21),
an image of said at least one periodic pattern (8a) is recorded by each sensor (2, 21), and
the cartesian position (X, Y) of the point of intersection (P) in a plane parallel to the second plane (xoy) defined by the two dimensions of the periodic pattern (8a) is calculated from the image obtained by the first sensor (2), and
the cartesian position (X, Z) of the point of intersection (P) in a plane (XOZ) perpendicular to the first plane (XOY) defined by the two dimensions of the periodic pattern (8a) is calculated from the image obtained by the second sensor (21).

9. The method as claimed in any one of claims 1 to 6, in which the frequency (fₒ) of the periodic pattern (8a), as calculated by the processing unit (4), is compared with the real frequency (Fₒ) of the periodic pattern (8a) in order to determine the position of the point of intersection (P) in a direction (Z) perpendicular to the a plane (XOY) defined by the two dimensions of said at least one periodic pattern (8a), as a function of the magnification index of the fixed observation system (I).
